(19) United States
(12) Patent Application Publication
(10) Pub. No.: US 2002/0040280 A1
(43) Pub. Date: Apr. 4, 2002

(54) System and method for refrigerant-based air conditioning system diagnostics

(76) Inventor: Stephen A. Morgan, West Chester, PA (US)

Correspondence Address: RATNER & PRESTIA, P O BOX 980, VALLEY FORGE, PA, 19482

(21) Appl. No.: 09/963,269

(22) Filed: Sep. 26, 2001

Related U.S. Application Data
(60) Provisional application No. 60/236,831, filed on Sep. 29, 2000.

(51) Int. Cl. G01M 7/00; G01M 10/00

(52) U.S. Cl. 702/114; 702/113

(57) ABSTRACT

A system and method for identifying refrigerant-based air conditioning system component-mode failures to provide field technician assistance in diagnosis and repair. A multiplicity of measurement probes for system pressure, system temperature, ambient temperature, ambient relative humidity and refrigerant identification are utilized with a microprocessor unit and a Weighted Probability Inference Engine (WPIE) process. Measured parameters are stored during specific modes of air conditioning system operation and are compared to a stored database of failure modes to determine potential system component-mode failures and provide troubleshooting guidelines. Specific failure modes are displayed to the user through a variety of interface devices.

This application is a continuation-in-part of U.S. Provisional Patent Application No. 60/236,831, filed Sep. 29, 2000.

### FIELD OF THE INVENTION

This invention relates generally to troubleshooting and repair guidelines for refrigerant-based air conditioning systems. More specifically, the present invention relates to a system and method to provide component-mode failure analysis of an air conditioning system based on a combination of software analysis and physical data measurements under specific air conditioning system operational conditions.

### BACKGROUND OF THE INVENTION

Refrigerant-based air conditioning systems are comprised of numerous components that can include, but are not limited to, compressor, condenser, evaporator, metering device such as a TXV valve or orifice tube, filter/dryer, accumulator and refrigerant charge. The object of any air conditioning system is to remove heat and humidity from a specified room or living space and expel the removed heat and humidity to the outside environment. The principles and laws governing the physics and mechanics of an air conditioning system are well known by those skilled in the art.

Most air conditioning systems are not manufactured or supplied with onboard system diagnostic indicators or features. When an air conditioning system fails to perform adequately the troubleshooting, diagnosis and repair of the air conditioning system is left to the field technician. System parameters such as pressure, temperature and electrical properties are measured by the field technician and compared to data charts supplied by the air conditioning system manufacturer. Often the manufacturer supplied data charts are not tailored to the specific air conditioner application parameters, or may be incomplete or incorrect. The field technician can also unknowingly introduce errors into the diagnosis through a misunderstanding of the measured data, a misunderstanding of the supplied manufacturer data or through inaccuracies inherit in old or outdated equipment.

Errors in air conditioning system diagnosis can lead to unnecessary costs to the customer, the technician or the original equipment manufacturer. A diagnosis error can easily lead to the replacement of a system component that is not at fault, or the cause of the system, wasting technician time and materials, thereby potentially transferring costs to the customer potentially causing erroneous warranty costs to the original equipment manufacturer.

In general, the majority of the air conditioning markets do not have standardized tools or procedures to facilitate efficient and effective air conditioning component-mode failure analysis. Technicians are left to rely upon the old technology of pressure gauge sets, temperature probes, voltage and current meters, intuition and past experience to determine component-mode failures. Furthermore, it is not unusual for published air conditioning troubleshooting and diagnostic guides to be incorrect or out of date. This is particularly true with the advent of alternate refrigerants replacing the more common refrigerant types in accordance with the Montreal Protocol.

Bright Solutions of Troy Mich. currently markets a microprocessor-based, refrigerant-based air conditioning system troubleshooting and component-mode diagnostic tool known as the A/C Investigator, part number E95000. This device has deficiencies, however, in that the A/C Investigator requires multiple probes and requires the technician to make manual corrections of data that do not fall within the recommended ambient operating conditions. Additionally, the A/C Investigator requires the air conditioning system to be operated with a specific RPM setting on the system compressor that is difficult to achieve and maintain.

There is a need for a refrigerant-based air conditioning system diagnostic tool that permits the compressor to be operated at “idle” speeds and requires no interpretation or correction of data by the technician. There is also a need for such a diagnostic tool to provide refrigerant charge purity analysis.

### SUMMARY OF THE INVENTION

The present invention is a device for testing a refrigerant based system. The device includes input ports for obtaining a operating parameters from the refrigerant based system; a memory for storing a baseline set of system operating parameters; a first processor to process the system's operating parameters based on the baseline operating parameters and generating a test result; a second processor for providing test results and prompts to the a user based on outputs from the first processor.

According to another aspect of the invention, the first processor includes a Weighted Probability Inference Engine (WPIE) to construct failure mode fingerprints of the refrigerant based system.

According to a further aspect of the invention, the failure mode fingerprints are based on historic data stored in the memory and the operating parameters.

According to still another aspect of the invention, an infrared probe measures temperatures of the refrigerant based system.

According to yet another aspect of the present invention, operating parameters of the refrigerant based system are obtained; baseline operating parameters are stored in memory; the operating parameters are processed based on the baseline operating parameters and a test result is generated; and the test results are provided to the user and the user is prompted based on the processing results.

These and other aspects of the invention are set forth below with reference to the drawings and the description of exemplary embodiments of the invention.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following Figures:

FIG. 1 is a perspective view of an exemplary embodiment of the present invention;

FIGS. 2A and 2B are cross-sectional views of an exemplary air conditioning system temperature measurement probe according to an exemplary embodiment of the present invention;

FIG. 3 is a side view of the air conditioning system pressure measurement probes utilized in the operation of an exemplary embodiment of present the invention;

FIG. 4 is a schematic diagram of the plumbing of an exemplary embodiment of the present invention;

FIG. 5 is a schematic block diagram of the electrical/logic connections of an exemplary embodiment of the present invention;

FIG. 6 is a flow chart of the Main Operating Process of an exemplary embodiment of the present invention;

FIG. 7 is a flow chart of the Self-Diagnostic sub-routine of the exemplary embodiment of FIG. 6;

FIG. 8 is a flow chart of the user air conditioning system Data Entry sub-routine of the exemplary embodiment of FIG. 6;

FIGS. 9A-C is a flow chart of the Weighted Probability Interference Engine (WPIE) process of an exemplary embodiment of the present invention;

FIG. 10 is a flow chart of the Refrigerant Identifier (EID) sub-routine of an exemplary embodiment of the present invention;

FIG. 11 is a flow chart of the Pressure Diagnostic (PDR) sub-routine of an exemplary embodiment of the present invention;

FIG. 12 is a flow chart of the Vent Temperature Diagnostic sub-routine of an exemplary embodiment of the present invention;

FIG. 13 is a flow chart of the Second Level Diagnostic sub-routine of an exemplary embodiment of the present invention; and

FIG. 14 is a flow chart of the Third Level Diagnostic sub-routine of an exemplary embodiment of the present invention.

### DETAILED DESCRIPTION

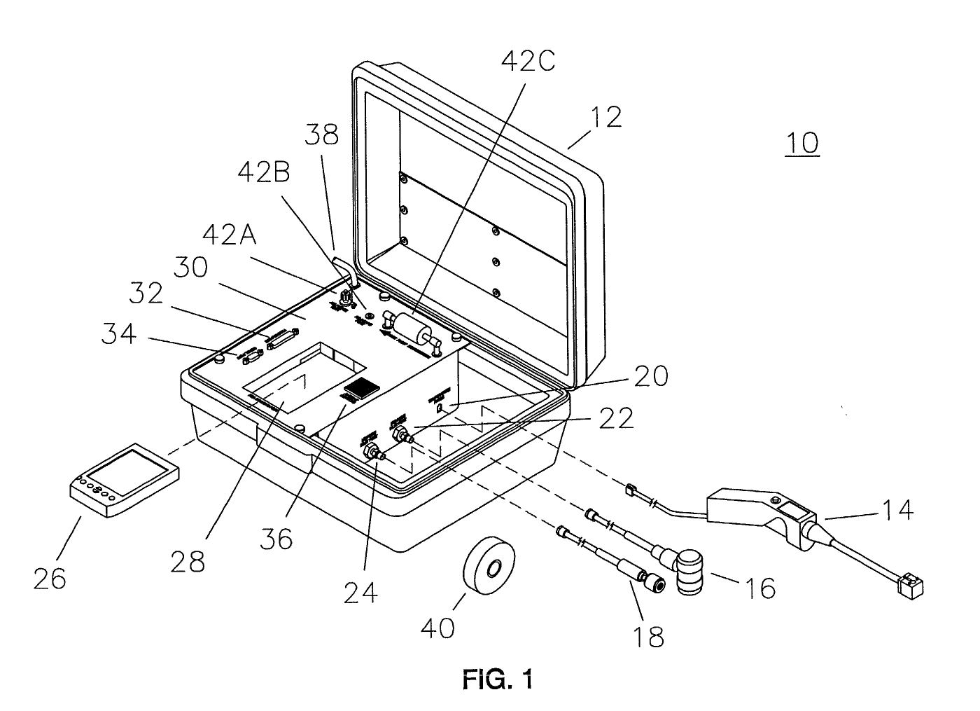

There is shown in FIG. 1, an exemplary air conditioning diagnostic system 10 and its various components. The exemplary system 10 is housed in a portable case 12 that provides component protection and storage. Temperature probe 14, high side pressure probe 16, and low side pressure probe 18 are supplied within case 12 and connect to ports 20, 22 and 24 respectively. Also included is display device 26 which docks in cradle 28 of top panel 30. In one embodiment of the present invention, display device 26 may be a Personal Digital Assistant (PDA), such as a 3Com Corporation of Santa Clara, Calif. Model Palm III PDA or a Handspring of Mountain View, Calif. Model VISOR PDA. In another embodiment of the present invention, display device 26 may be coupled to system 10 via a wireless connection, such as an RF link or an IR link for example. In yet another embodiment of the present invention, display device 26 may be fixedly mounted to top panel 30 and may be an LCD display or a plasma display, for example.

Printer and serial data output ports 32 and 34 are supplied hard mounted to top panel 30 and hard wired to internal electronics (not shown). Ambient sensing port 36 is provided on top panel 30 and, in a preferred embodiment of the present invention, consists of a perforated metal screen positioned over ambient temperature and relative humidity sensors (not shown) located under top panel 30. Power to system 10 may be provided through various means, such as power cord 38 hard mounted to top panel 30 and hard wired to internal electronics to provide standard AC wall electrical power and/or an external or internal DC power source. An infrared emitter 40 is provided and preferably stowed in the lid of housing 12 and will be utilized during air conditioning system component temperature measurements. Optional components air purge vent 42A, air intake port 42B, sample filter 42C and sample exhaust (not shown) are provided when the refrigerant identifier option is supplied. The refrigerant identifier option is manufactured by the Applicant's Assignee, Neutronics Incorporated, Model ACR-2000 and is described in U.S. Pat. No. 5,610,398.

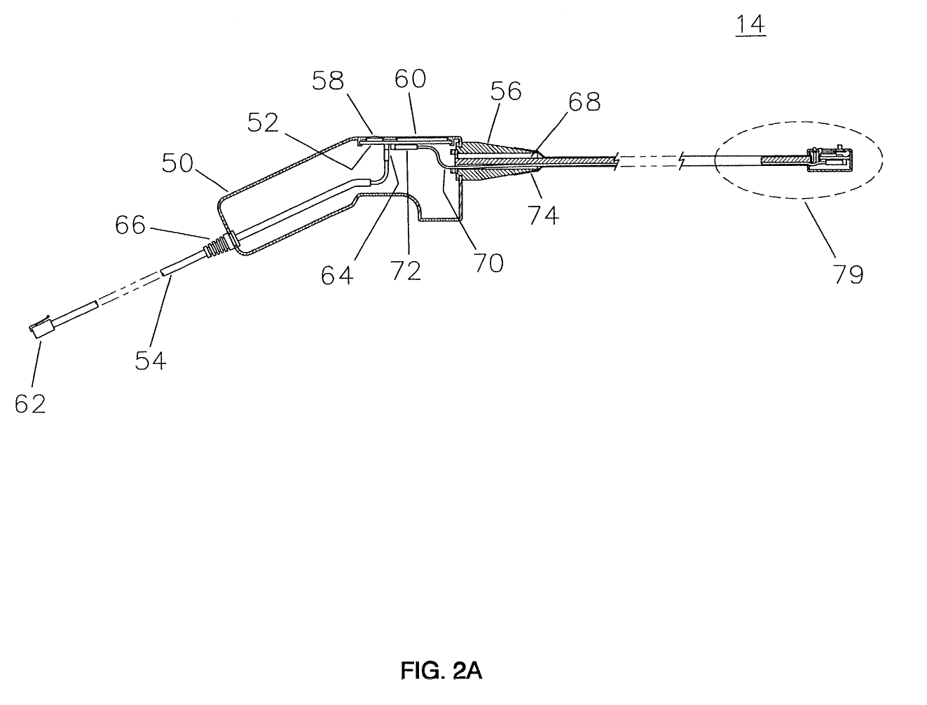

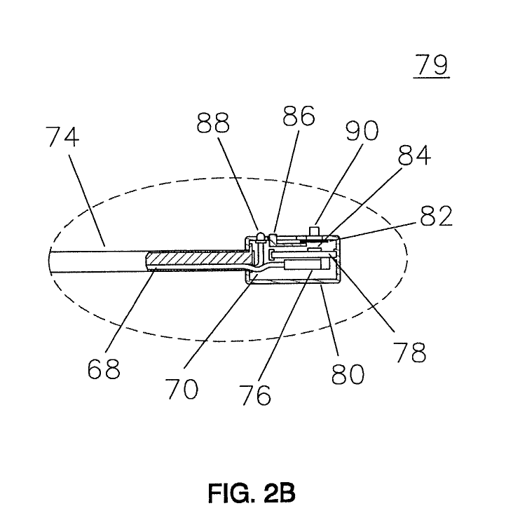

There is shown in FIG. 2, an exemplary air conditioning system temperature measurement probe 14 that will be utilized with an infrared emitter 40, such as thermal target tape, to measure air conditioning system component temperatures and air conditioning system vent temperatures. The temperature probe design is capable of operating as an integral component of the preferred embodiment of the invention or as a stand-alone temperature-measuring device. Handgrip 50 provides a grip for the user and also houses main circuit board 52, communication line 54 and cowling 56. Main circuit board 52 preferably contains tactile switch 58 and optional digital display 60. Tactile switch 58 will be utilized to inform the microprocessor (not shown in this figure) of the preferred embodiment of the invention to read the current temperature at the sensing end of the temperature probe 14. Digital display 60 will inform user of what temperature measurements are to be taken and at what time; or, in the stand-alone mode, the display 60 provides direct temperature measurement values.

Communication to the microprocessor is achieved through communication line 54, which is terminated on one end with a mating connector 62 to probe port 20 (shown in FIG. 1), supported by strain relief 66 and connected to main circuit board 52 through connector 64. Cowling 56 provides the mounting and passageway for flexible support 68, communication line 70 and protective covering 74. In a preferred embodiment, flexible support 68 is an 8 AWG copper wire fitted with end plates to provide secure mounting. Communication line 70 connects to the main circuit board 52 through connector 72 and to sensor circuit board 78 through connector 76 (shown in FIG. 2B). Protective covering 74 is preferably high-strength heat shrink tubing or material of other means that will provide ease of mounting and provide probe protection.

FIG. 2B is a detailed view of sensor end 79 of temperature measurement probe 14. As shown in FIG. 2B, sensor housing 80 houses sensor circuit board 78, filter 82 (such as an infrared window), foil thermal slide 86 and viewing LED 88. Sensor circuit board 78 contains infrared temperature sensor 84, such as that supplied by Melexis of Concord, N.H., under part number MLX90601 and is known to those skilled in the art. When prompted by display 60, the user will apply infrared emitter 40 (shown in FIG. 1) to the component location indicated (not shown). In one exemplary embodiment, infrared emitter 40 is a thermal target tape, such as a bright colored electrical tape that radiates infrared energy back to the infrared sensor. Normally the air conditioning system component will not always be of proper color to permit the use of infrared technology. When the component temperature is to be measured the foil thermal slide 86 will be positioned away from the infrared window 82. The face of the infrared window 82 will be positioned onto the measurement location as illuminated by LED 88 and held into position by locating pins 90. Tactile switch 58 (shown in FIG. 2A) is then depressed to alert the microprocessor to store the temperature reading transmitted from infrared sensor 84, through sensor circuit board 78, through connector 76, through communication line 70, through connector 72, into main circuit board 52, out connector 64, through communication line 54 and out connector 62. The aforementioned communication lines, connectors and circuit boards also provide the power required for display 60, LED 88 and infrared sensor 84 operation.

When vent temperatures are to be taken the same procedure will be followed with the exception of positioning the foil thermal slide 86 over the infrared window 82. Infrared thermal technology is not capable of measuring direct air temperature. In order for infrared thermal technology to measure temperature, a thermally conductive and infrared emissive surface is required to emit infrared energy to the infrared detector. The use of foil thermal slide 86, which consists of a sliding mechanism that positions a thin metallic foil black body in front of the infrared detector 84, provides a surface indicative of air temperature. The foil must be sufficiently thin to provide adequate temperature change response through contact with the air. For a stand-alone version of the temperature probe 14, connector 62, communication line 54 and connector 64 transfer power and a temperature output signal to an external device (not shown).

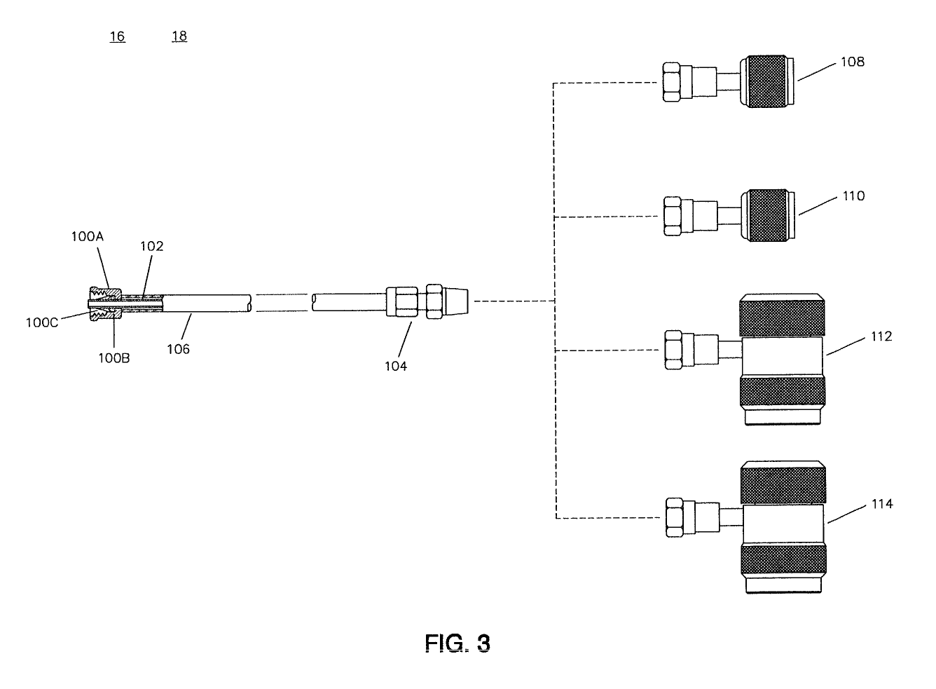

There is shown in FIG. 3 an exemplary high side pressure probe 16 and low side pressure probe 18 for use with the preferred embodiment of the invention to transfer refrigerant pressure directly from the air conditioning system into the invention for pressure analysis by a pressure transducer. Low side pressure probe 18 will also be utilized to transfer a vapor refrigerant sample from the air conditioning system into the invention for use by the refrigerant identifier 42. A compression-type connector consisting of nut 100A, front ferrule 100B and rear ferrule 100C is swaged onto transfer tube 102. Transfer tube 102 is preferably a small-bore tube of material suitable for the expected pressure ranges that will minimize refrigerant use and loss by its inherently small internal volume.

Transfer tube 102 is connected to a compression-type male connector fitting 104 known to those skilled in the art. Outer cover 106 provides transfer tube 102 protection from abuse and damage and is preferably constructed of a tough plastic material, such as polyethylene. Male connector 104 is permanently connected to refrigerant coupler 108, 110 112 or 114. Coupler 108 is a high side R12 refrigerant coupler known to those skilled in the art. Coupler 110 is a low side R12 refrigerant coupler known to those skilled in the art. Coupler 112 is a high side R134a refrigerant coupler known to those skilled in the art. Coupler 114 is a low side R134a refrigerant coupler known to those skilled in the art. Other coupler types maybe utilized as dictated by the refrigerant types per air conditioning market sectors. High side coupler 16 and low side coupler 18 will be connected to high side port 22 and low side port 24 (shown in FIG. 1) of the invention. The coupler end of each hose will be connected to the high side and low side service ports of the air conditioning system. Low side probe 18 provides a vapor refrigerant pathway through low side coupler 110 or 114, through transfer tube 102 and out fitting 100 into the invention for pressure analysis and refrigerant purity analysis. High side probe 16 provides a liquid refrigerant pathway through high side coupler 108 or 112, through transfer tube 102 and out fitting 100 into the invention for pressure analysis.

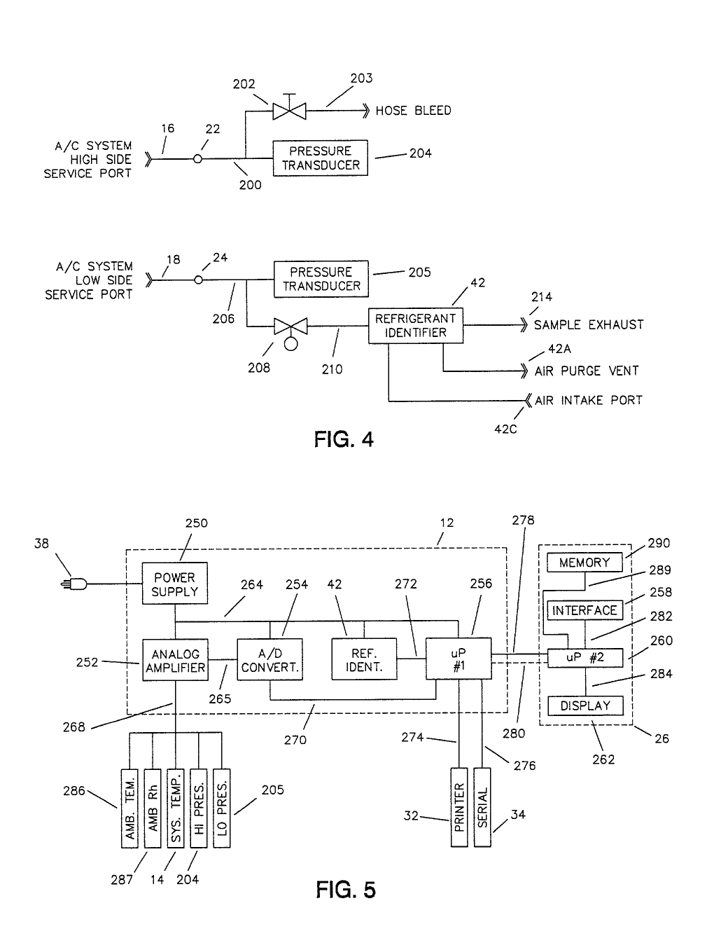

There is shown in FIG. 4 a plumbing schematic diagram of a preferred embodiment of the invention. High side probe 16 and low side probe 18 are connected to the high and low side service ports of the air conditioning system, respectively. High-pressure liquid refrigerant travels through high side probe 16 and through high side port 22 into the invention. Liquid refrigerant travels through plumbing line 200 to pressure transducer 204 and manual bleed valve 202. Pressure transducer 204 can be any pressure transducer suitable for exposure to liquid refrigerant, such as that supplied by Measurement Specialties of Valley Forge, Pa. under part number MSP-300-500-P-N-1. Liquid refrigerant trapped in high side probe 16 and plumbing line 200 can be manually relieved through valve 202 and plumbing 203 after completion of testing. Low-pressure vapor refrigerant travels through low side probe 18 and through low side port 24 into the invention. Vapor refrigerant travels through plumbing line 206 to pressure transducer 205 and solenoid valve 208. Pressure transducer 205 is of the same construction as pressure transducer 204 connected to the high-pressure plumbing 200 and provides an electrical signal proportional to the amount of pressure incident upon the transducer. Solenoid valve 208 opens when so commanded by the microprocessor to admit vapor refrigerant gas through plumbing line 210 into refrigerant identifier 42 and out sample exhaust port 214. Refrigerant identifier 42, air purge vent 42A and air intake port 42C are all components supplied with the refrigerant identifier manufactured by Applicant's Assignee, Neutronics Incorporated Model ACR-2000 and described in U.S. Pat. No. 5,610,398.

FIG. 5 depicts the electrical/logic connections of an exemplary embodiment of the invention. Power cord 38 supplies power from an external source into power supply 250. Power cord 38 can be of standard AC wall plug construction or can be of DC battery connection design. Power supply 250 regulates and cleans input power and distributes power through conductor 264 to analog amplifier 252, A/D converter 254, refrigerant identifier 42 and microprocessor #1 256. Analog amplifier 252 receives signals from high-pressure transducer 204, low pressure transducer 205, system temperature probe 14, ambient temperature sensor 286 and ambient relative humidity sensor 287 through communication link 268. Ambient temperature sensor 286 is a solid-state semi conductor device known to those skilled in the art, such as part number LM50 supplied by National Semiconductor Corporation of Santa Clara, Calif. Ambient relative humidity sensor 287 is a variable capacitance device known to those skilled in the art such as part number 232269190001 supplied by Phillips Semiconductors of Eindhoven, The Netherlands.

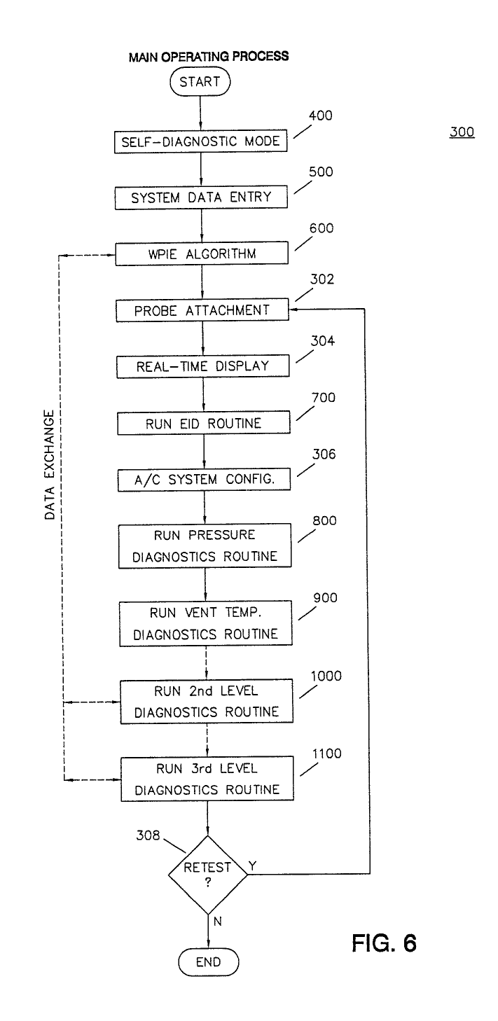

Analog amplifier 252 boosts the strength of the input signal and transfers the boosted signal to A/D converter 254 through communication line 265. A/D converter 254 converts analog signals into digital signals for transfer through communication line 270 to microprocessor #1 256. Microprocessor #1 256, such as supplied by Phillips Semiconductors of Eindhoven, The Netherlands under part number 80C552, utilizes input signals from A/D converter 254 and refrigerant identifier 42, through line 272, to operate main operating process 300 (shown in FIG. 6) and directs output of information to printer port 32 through line 274, serial port 34 through line 276, and display device 26 through hard-wired communication line 278 or radio frequency communication 280. Display device 26 can be any device deemed suitable to perform the user interface necessary for proper operation of the invention. A PDA, such as a 3Com Corporation of Santa Clara, Calif. Model Palm III Personal Digital Assistant or a Handspring of Mountain View, Calif. Model VISOR Personal Digital Assistant, device is utilized in a preferred embodiment of the invention and contains a second microprocessor 260. Communication lines 282, 284 and 289 relay data and instructions between microprocessor #2 260, user interface 258, display module 262 and memory 290 to provide instructions during testing, invention status and test results to the user. Although the exemplary embodiment contemplates two separate microprocessors, those of skill in the art understand that a single microprocessor may be used as desired.

FIG. 6 depicts the flow chart of main operating process 300. Upon power up of the invention, at Step 400, a self-diagnostic test is performed. Following successful completion of self-diagnostic test 400, at Step 500, a system data entry subroutine is entered prompting the user to enter specific information about the specific air conditioning system to be tested. At Step 600, the WPIE process (described in detail below) builds failure mode “fingerprints” based upon data stored in memory 290 (shown in FIG. 5). The “fingerprints” will be utilized with 2^{nd} 1000 and 3^{rd} 1100 Level Diagnostic testing to determine air conditioning system component-mode failures. At Step 302, the user is instructed to connect high side pressure probe 16 and low side pressure 18 to the low side and high side ports, respectively, of the air conditioning system. At Step 304, real time system pressures and real time ambient temperature and relative humidity data are presented to the user in real-time on display 262. At Step 700, an EID sub-routine makes a determination of refrigerant purity within the air conditioning system. At Step 306, (A/C system configuration) the user is instructed on how to configure the air conditioning system for testing. Instructions are provided pertaining to cooling control settings, sun load, window positions, blower speeds, or any other specific setting that may be required for testing the specific application. When the user indicates completion of air conditioning configuration completion, pressure diagnosis sub-routine (Step 800) determines pressure component-mode air conditioning system failures. Pressure testing will be followed by vent temperature diagnostic sub-routine (Step 900) whereby the effective cooling of the air conditioning system is evaluated. If no significant cause for system failure has been established the user is directed to 2^{nd} Level Diagnostics sub-routine (Step 1000) for additional testing, otherwise the session will end. Under 2^{nd} level diagnostics sub-routine 1000 the user is guided through a more in-depth analysis involving the measurement of system pressures and component temperatures to calculate the differential temperature across air conditioning system components. If no significant cause for system failure has yet been established the user is directed at Step 1100 to 3^{rd} Level Diagnostics sub-routine, otherwise the session ends. Under 3^{rd} level diagnostics sub-routine 1100 the user is guided through additional analysis involving the measurement of system pressures and component temperatures to calculate the differential temperature across air conditioning system components under different operating conditions. When 3^{rd} level diagnostics sub-routine 1100 has been completed the user will be informed of the findings of the testing on display 262. All analysis data will be available to the user for downloading into external computers or printers (not shown). At Step 308, the user is given an opportunity to retest the existing air conditioning system with a retest prompt. The user can choose to retest, and the process will return back to probe attachment Step 302, otherwise the session ends.

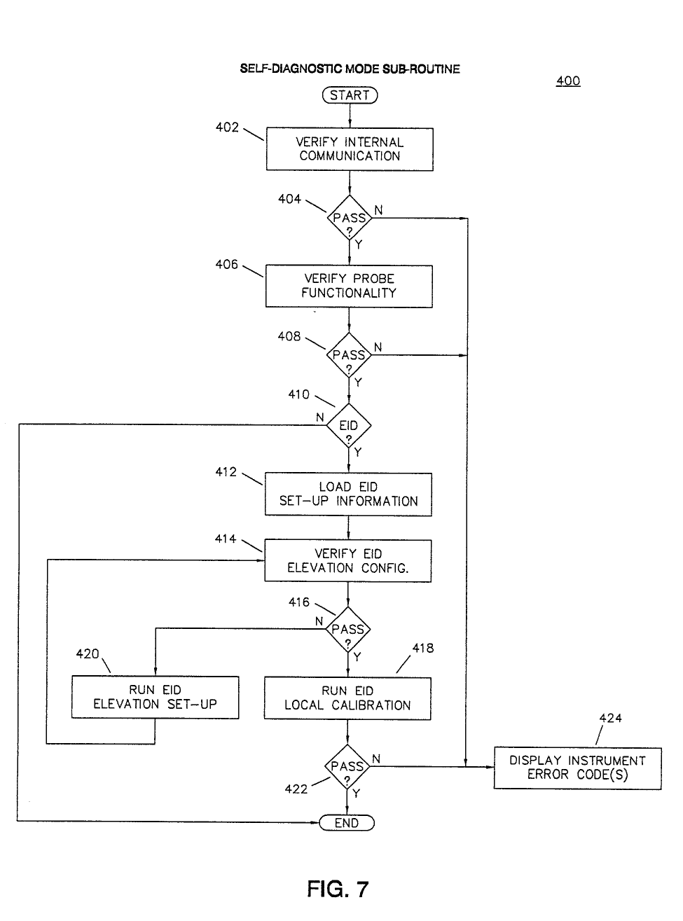

FIG. 7 depicts the Self-Diagnostic Mode sub-routine 400 of the main operating process 300 of a preferred embodiment of the invention. At Step 402 (Verify Internal Communication), all internal communication lines are verified to be operational through means known to those skilled in the art. At Step 404, a determination is made if the communication test was verified. At Step 424, failure of the communication test will be reported to the microprocessor and detected error codes will be displayed. If the communication step passes, at Step 406 (Verify Probe Functionality) all probe functions are test to verify proper electrical attachment, electrical function, calibration and status. At Step 408, a determination is made if the probe test was verified. At Step 424, failure of the probe test will be reported to the microprocessor and detected error codes will be displayed 424. If the probe test passes, at Step 410, an inquiry is sent to the microprocessor to determine if the refrigerant identifier is installed in the invention. The refrigerant identifier will be an expensive feature to the invention and may not be included with every model. If at Step 410, a refrigerant identifier is identified present, at Step 412 (Load EID Set-Up Information) data such as factory calibration, identifier type, local calibration and local elevation set-up is retrieved from stored memory. If no refrigerant identifier is present the sub-routine will end.

At Steps 414, 416, refrigerant identifier local elevation settings will be confirmed. If the local elevation requires adjustment, at Step 420, the user is instructed how to make the adjustment. The elevation is then verified again as aforementioned through steps 414 and 416. When the local elevation has been properly set, at Step 418, the refrigerant identifier will be locally calibrated and, at Step 422, the calibration is confirmed. If the calibration is verified the sub-routine ends and control will return to the main operating process 300. If the calibration fails, at Step 424, detected error codes will be displayed on display 262.

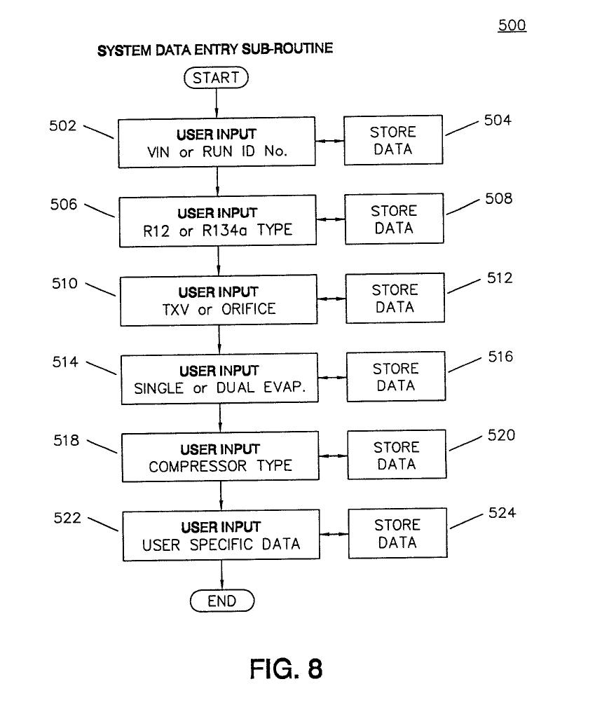

System Data Entry sub-routine 500 is depicted by FIG. 8. The user will input information specific to the air conditioning system being tested. In a preferred embodiment of the invention, the user will input the Vehicle Identification Number or the test run number (Step 502), the refrigerant type (Step 506) the refrigerant metering device type (Step 510), define the system as a single or dual evaporator type (Step 514), indicate the compressor type (Step 518), and enter user specific data (Step 522) such as, but not limited to, name, address or customer name information. All entered data is stored into the memory (not shown) at Steps 504, 508, 512, 516, 520 and 524 for use in display reporting, printouts and downloads. At he completion of Step 522, the Sub-routine ends and returns to main operating process 300.

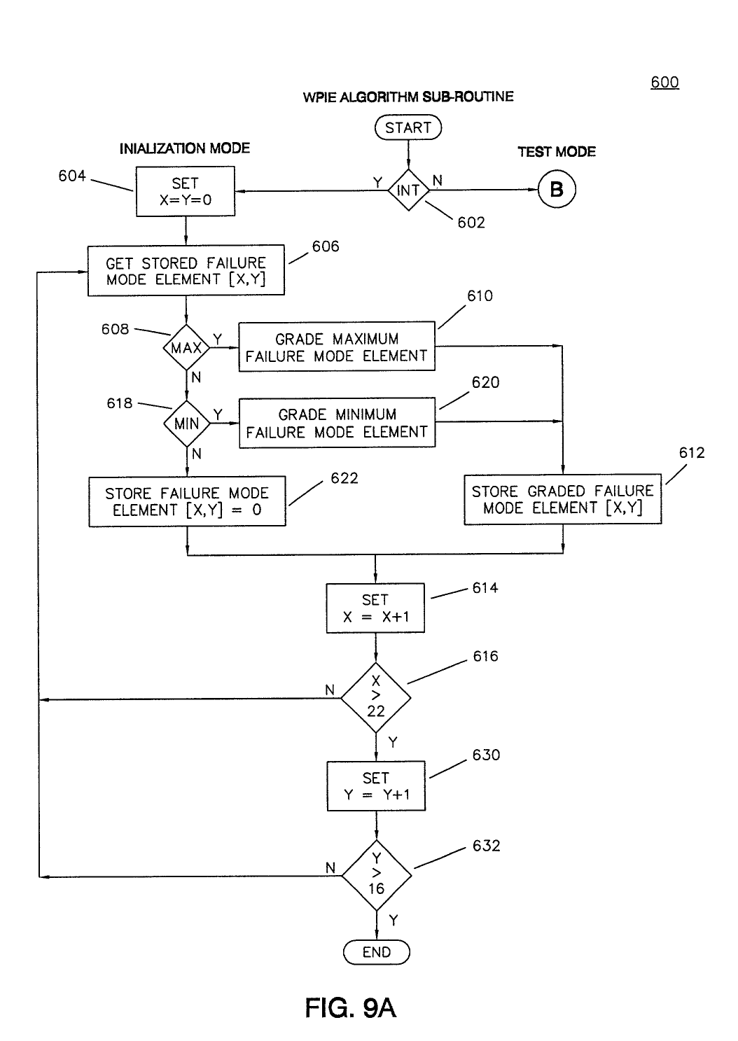

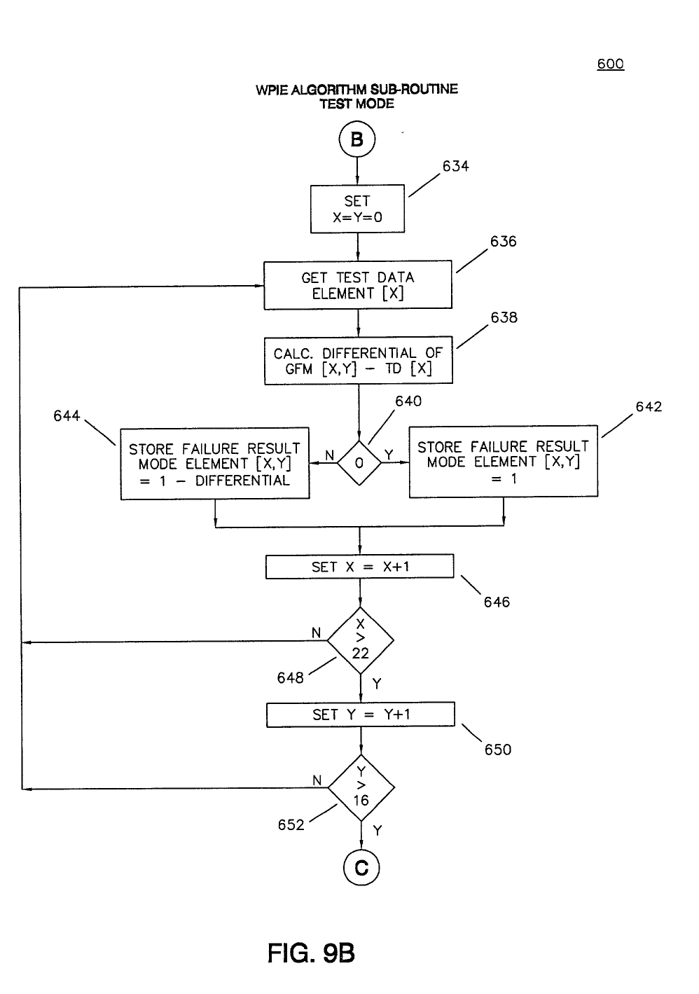

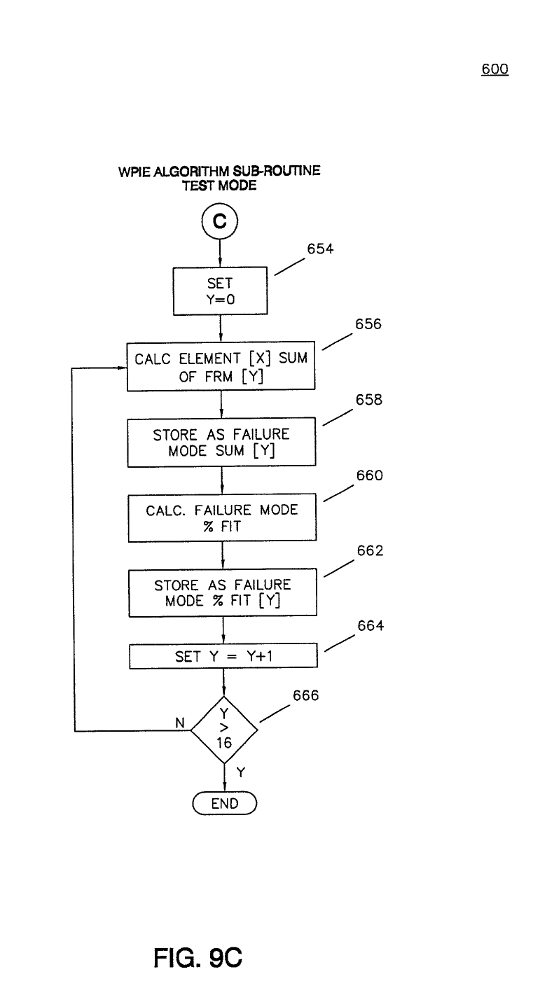

FIG. 9A, FIG. 9B and FIG. 9C depict a flow chart of the Weighted Probability Inference Engine (WPIE) process 600. In a preferred embodiment of present invention, the instrument contains permanent memory storage of failure modes in matrix form and is recalled through the use of variable [Y]. Each failure mode matrix contains a multiplicity of elements denoted by the variable [X]. Each element represents a specific parameter of the air conditioning system. This system of elements is fashioned to create a “fingerprint” of conditions that constitute a specific failure mode as derived through laboratory testing. Maximum and minimum values are also stored in the permanent memory for each failure mode element that define acceptable ranges of each specific air conditioner parameter as determined through laboratory testing. In the preferred embodiment of the invention the failure modes may include, but are not limited to, the following modes as defined by mode number [Y].

### [Y] Mode Description

0 Low Performing Compressor

1 Evaporator Air Flow Restriction

2 Missing Orifice Tube

3 Slipping Compressor Clutch or Fan Belt

4 Cooling Fan Disconnected

5 Blocked Orifice Tube

6 No Problem Detected

7 Condenser Restriction

8 Blend Door Malfunction

9 Blocked Condenser Air Flow

10 Pressure Switch Setpoint Fault

11 Air in Refrigerant Charge

12 30% Low Refrigerant Charge

13 40% Low Refrigerant Charge

14 Suction Side Restriction

15 Excessive Refrigerant Charge

16 TXV Valve Fault

In turn, in the preferred embodiment of the invention each failure mode may contain, but is not limited to, the following listing of elements denoted by the variable [X].

### [X] Element Description

0 Compressor Clutch Cycle Speed

1 Maximum High Side Pressure

2 Minimum High Side Pressure

3 Minimum Low Side Pressure

4 Maximum Low Side Pressure

5 Compressor Inlet Temperature

6 Compressor Outlet Temperature

7 Compressor Temperature Gradient

8 Condenser Inlet Temperature

9 Condenser Outlet Temperature

10 Condenser Temperature Gradient

11 Metering Device Inlet Temperature

12 Metering Device Outlet Temperature

13 Metering Device Temperature Gradient

14 Evaporator Inlet Temperature

15 Evaporator Outlet Temperature

16 Evaporator Temperature Gradient

17 Accumulator Inlet Temperature

18 Accumulator Outlet Temperature

19 Accumulator Temperature Gradient

20 Vent Inlet Temperature

21 Vent Outlet Temperature

22 Vent Temperature Gradient

The basic matrix form of [element, mode] or [X, Y] is utilized throughout the WPIE process to construct failure mode fingerprints, construct actual test data fingerprints, compare actual test data fingerprints to failure mode fingerprints, sort comparison results, and finally generate a component-mode failure to user for the specific air conditioning system being tested. In a preferred embodiment of the invention, WPIE process 600 begins at Step 602, by making a determination as to operate the sub-routine in initialization or test mode. The initialization mode constructs the failure mode fingerprint or Graded Failure Mode (GFM) utilizing the data stored in the permanent memory for the element type and element minimum and maximum values. Initially, at Step 604, variables [X] and [Y] are set to zero. At step 606, the value of element [0] stored under failure mode [0] will be retrieved from memory 290. A determination will be made to rate the retrieved value as exceeding a minimum or maximum by comparing the retrieved element value to the minimum and maximum values stored for the element type. At Step 608, maximum values are determined utilizing Eq. 1:

Mode Element [0,0]>Maximum Limit [0] Eq. 1

At Step 610, the value of failure mode element [0,0] is then graded using Eq. 2 to produce the first element of the Graded Failure Mode or fingerprint.

Graded Failure Mode Element [X,Y]=(Element [X]−Max Limit [X])/(Max Limit [X]−Min Limit [X]) Eq. 2

At Step 612, this value is stored under Graded Failure Mode Element [0,0]. At Step 618, minimum values are determined utilizing Eq. 3:

Mode Element [0,0]<Minimum Limit [0] Eq. 3

At Step 620, the value of failure mode element [0,0] is then graded using Eq. 4 to produce the first element of the Graded Failure Mode or fingerprint.

Graded Failure Mode Element [X,Y]=(Element [X]−Min Limit [X])/(Max Limit [X]−Min Limit [X]) Eq. 4

At Step 612, this value is stored under Graded Failure Mode Element [0,0]. At Step 622, element values that do not exceed either the maximum or minimum limit would be stored to zero. At Step 617, Variable [X] will increase by one count and, at Step 616, [X] will be verified that it does not exceed the amount of elements contained in each failure mode fingerprint. In the exemplary embodiment, the maximum value for [X] is 22, but the invention is not so limited in that the maximum number of elements [X] may be defined as necessary to accomplish the desired functions of the invention.

At Step 606, the process retrieves the value of element [1] stored under failure mode [0] from the permanent memory. The entire process described above will be repeated until all elements of the Graded Failure Mode [0] have been constructed. In the case of the preferred embodiment of the invention this would require twenty-three iterations to complete Graded Failure Mode [0]. When Graded Failure Mode Element [0,22] has been stored, at Step 616, variable [X] will exceed the amount of elements available (22) under test. At Step 630, variable [Y] will then increase by one count. The entire process described above is now repeated for all elements of Failure Mode [1] to produce Graded Failure Mode [1]. Once again, this process is repeated until all Graded Failure Modes have been constructed and stored into the memory. For the preferred embodiment of the invention this would require seventeen iterations to construct all Graded Failure Mode Fingerprints (0 through 16). As previously mentioned above with respect to variable [X], the invention is not limited to 17 iterations of variable [Y], in that additional modes may be defined and included or fewer modes may be utilized based on the specifics of the system under test or other considerations. The Initialization session will now end and control will return to the main program process 300.

In the Test Data mode of exemplary WPIE process, test data gathered and stored to memory from the air conditioning system under test during the 2^{nd} Level Diagnostic sub-routine (Step 1000) and 3^{rd} Level Diagnostic sub-routine (Step 1100) will be graded and then compared to the data elements of the Graded Failure Modes constructed in the Initialization mode of the WPIE process. This comparison will yield a Failure Result Mode matrix that will be utilized to determine component-mode failure probabilities. At Step 634, variables [X] and [Y] will be set to zero. At Step 636, test data from 2^{nd} 1000 or 3^{rd} 1100 Level Diagnostic sub-routine testing will retrieved from the memory storage bank Test Data Element [0]. At Step 638, the difference between the Test Data Element [0] and the Graded Failure Mode Element [0,0] will determined using Eq. 5:

Graded Failure Mode Element [0,0]−Test Data Element [0] Eq. 5

At Step 640, the resulting value will be checked to see if it equals zero. At Step 642, for values that equal zero the Failure Result Mode Element [0,0] will be stored as one (1), which denotes a perfect fit. At Step 644, For values that do not equal zero the Failure Result Mode Element [0,0] will be stored according to Eq. 6:

1−(the difference/Graded Failure Mode Element [0,0] Eq. 6

At Step 646, variable [X] is increased by one count and, at Step 648, verified that its value does not exceed the number of elements available in the Graded Failure Mode Fingerprint. The above process continues until all elements of Failure Result Mode [0] have been completed. In the preferred embodiment of the invention this would equate to Failure Result Mode [0,22]. At Step 650, The [Y] variable is increase by one count and, at Step 652, verified not to exceed the number of Graded Failure modes. The above process continues until all Failure Result Mode Fingerprints have been constructed and stored. In the preferred embodiment of the invention this would require seventeen iterations to complete. At Step 654, variable [Y] will be reset to zero. At Step 656, the elements of Failure Result Mode [0] will be totaled and, at Step 658, stored as Failure Mode Sum [0]. The Failure Mode % Fit will be calculated 660 according to Eq. 7:

Failure Mode Fit [Y]=100×(Failure Mode Sum [Y]/Number of Elements) Eq. 7

At Step 662, the results of Eq. 7 is stored as Failure Mode % Fit [0]. At Step 664, Variable [Y] will increase one count and the process of determining Failure Mode % Fit will be repeated in order to construct all Failure Mode % Fit files. In the preferred embodiment of the invention seventeen iterations would be required. The resulting Failure Mode % Fit files will provide a percent probability for each of the established failure modes to be utilized in the 2^{nd} and 3^{rd} Level Diagnostic sub-routine of the main operating process 300. The session will now end and revert to main operating process 300.

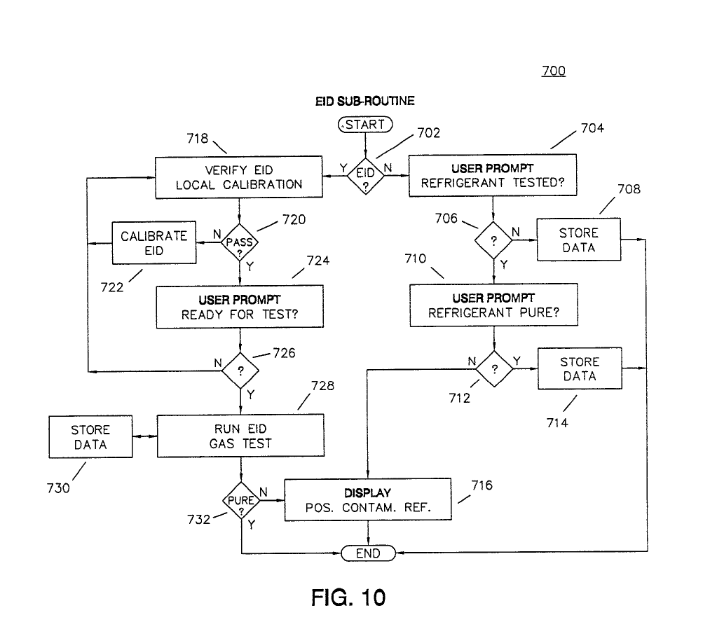

Refrigerant status is determined with the EID sub-routine 700 depicted in FIG. 10. Sub-routine 700 will first determine, at Step 702, if the refrigerant identifier feature is present. If no refrigerant identifier is found, at Step 704, the user will be prompted if the air conditioning system refrigerant has been tested with an external refrigerant identifier. At Step 706, the user response is input. If no refrigerant testing has been performed, at Step 708, this information is stored to memory. If the refrigerant has been tested by an external refrigerant identifier, at Step 710, the user will be prompted to identify if the testing reveled pure refrigerant. Pure refrigerant is defined as 98% by weight of the specified refrigerant type with less than 5% by weight air content. At Step 712, the user response is entered. If refrigerant is determined to be pure, at Step 714, the data will be stored to memory. If the refrigerant is determined not to be pure a message of “possible refrigerant contamination” will be given at Step 716.

If, at Step 702, the refrigerant identifier is found to be present, at Steps 718, 720, the local calibration of the refrigerant identifier will be verified. If the calibration has expired it will be repeated at Step 722, and subsequently verified at Step 718. If the local calibration is found to be valid the user will be prompted to start the testing at Step 724. At Step 726, upon user input to start test, the microprocessor will admit a vapor refrigerant sample from the air conditioning low side service port into the refrigerant identifier for testing at Step 728. At Step 730, the results of the refrigerant testing are stored into memory. At Step 732, a determination will be made of refrigerant purity. Pure refrigerant is defined as 98% by weight of the specified refrigerant type with less than 5% by weight air content. If, at Step 732, the refrigerant is found to be contaminated, at Step 716, a message of “possible refrigerant contamination” will be given. If, at Step 732, the refrigerant is found to be pure the session will end and control will return to the main operating process 300. With the presence of refrigerant identifier 42, the user will have the option to purge air detected within the refrigerant charge with the “Air-Purging” feature of the refrigerant identifier.

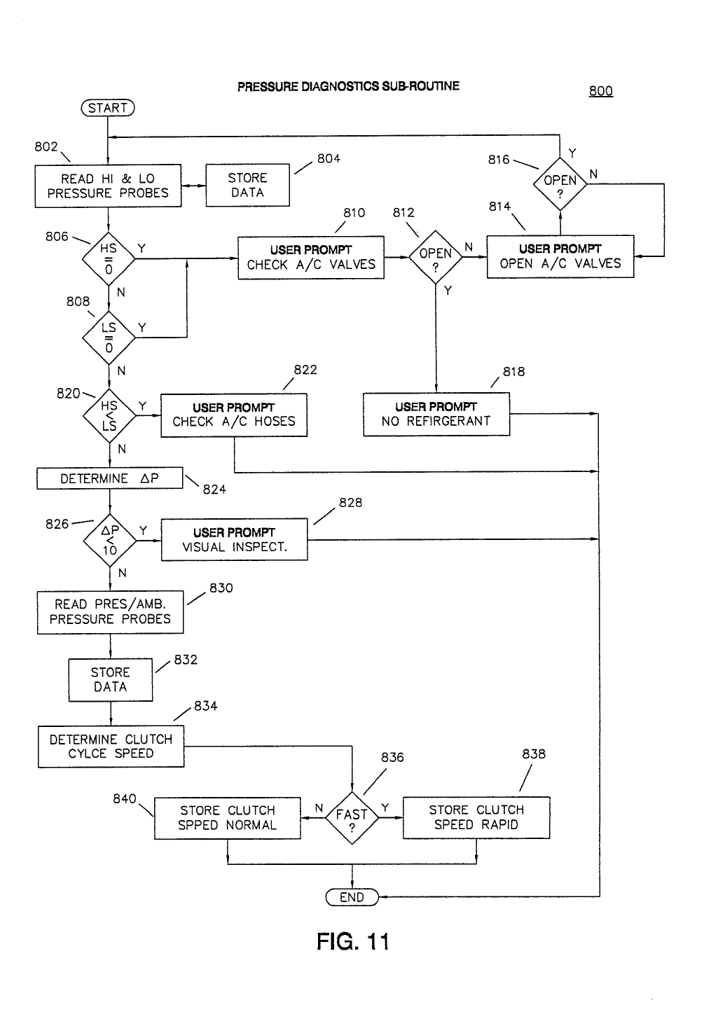

FIG. 11 depicts the Pressure Diagnostics sub-routine 800 of the main operating process 300. At Step 802, data from high side pressure transducer and low side pressure transducer will be read by the microprocessor for a 5-minute period. At Step 804, the maximum and minimum high side and low side pressures will be stored to memory during this period. At Step 806, a determination will be made if the high side pressure is equal to 0 psi. At Step 808, a determination will be made if the low side pressure is equal to 0 psi. If the high side or low side pressures are equal to 0 psi, at Step 810, the user will be prompted to verify that the low side and high side pressure probe coupler valves are open. At Step 812, the user will input the response. If the probe coupler valves are closed the user will be prompted to open them at Step 814. Upon user response that the probe coupler valves have been opened, as determined at Step 816, the sub-routine will restart at Step 802, by reading the high side and low side pressure transducer readings.

If the high side and low pressures both equal 0 psi and the probe coupler valves are reported to be open at Step 812, the user will be prompted, at Step 818, that the air conditioning system has no refrigerant charge, the session will end and control will return to the main operating process 300. If the high side pressure is not equal to 0 psi and the low side pressure is not equal to 0 psi, a determination will be made, at Step 820, if the high side pressure is less than the low side pressure. If it is determined that the high side pressure is less than the low side pressure, the user will be prompted, at Step 822, to inspect the air conditioning plumbing to verify that the high side and low side connections to the compressor are not reversed, the session will end and control will return to the main operating process 300.

If the high side pressure is determined to be higher than the low side pressure then, at Step 824, the difference in pressure will be calculated as high side pressure less low side pressure. At Step 826, a determination will be made if the difference in pressure is less than 10 psi. If the difference in pressure is less than 10 psi the user will be prompted, at Step 828, to inspect the air conditioning system compressor electrical connections, fan belts and other possible compressor faults, the session will end and control will return to the main operating process 300. If the difference in pressure is greater than 10 psi the high side pressure transducer and the low side pressure transducer data streams will be read, at Step 830, for a 5-minute period. The data collected and stored at Step 832 from the low and high side pressure transducers will be utilized, at Step 834, to determine the air conditioning compressor clutch cycling speed. The clutch cycling speed is determined by counting the number of sinusoidal cycles in the pressure readings over a 5 minute period. At Step 836, a determination will be made as to the status of the clutch cycle speed. Clutch cycle speed will be determined to be normal if there is less than 15 cycles in a 2-minute period, otherwise the speed will be determined to be rapid. The clutch cycle speed status will be stored to memory as normal, at Step 840, or rapid, at Step 838, for use with the WPIE process during subsequent testing. The session will end and control will return to the main operating process 300.

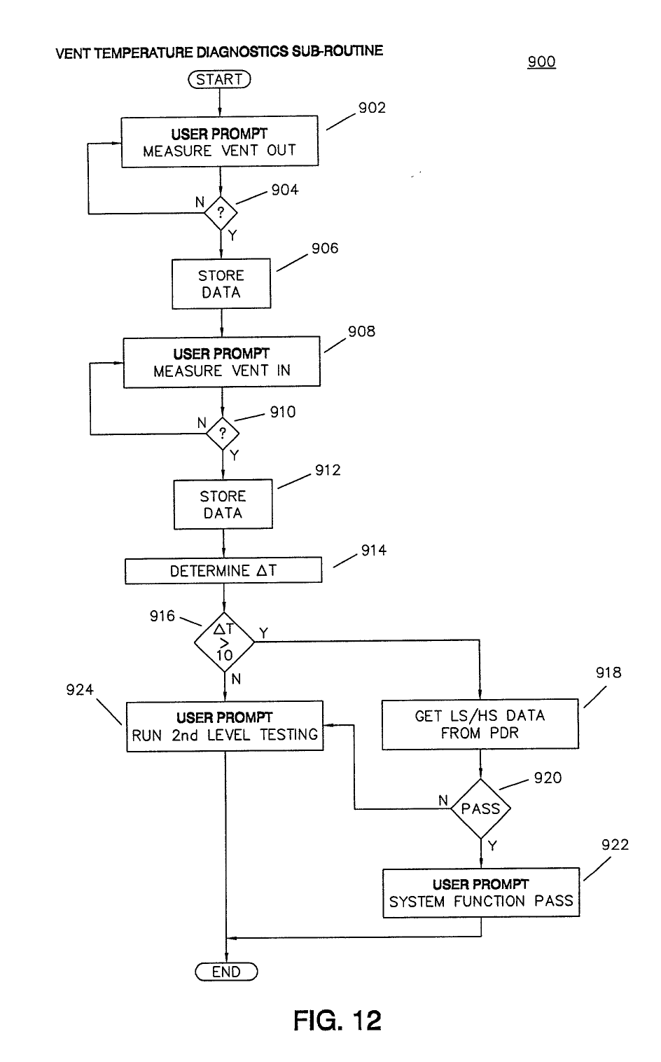

FIG. 12 depicts the Vent Temperature Diagnostics sub-routine 900 of the main operating process 300. At Step 902, the user will be prompted to measure the vent out temperature using temperature probe 14. The user will position the vent probe measuring tip 80, with the foil thermal slide 86 positioned over the sensing window 82, in the air stream (not shown) exiting the vent of the air conditioning system. When the probe is properly positioned, at Step 904, the tactile switch 58 of probe 14 is depressed to indicate the measurement is complete. At Step 906, The temperature data from the probe will be stored into memory. At Step 908, the user will be prompted to measure the vent in temperature using the temperature probe. The user will position the vent probe measuring tip, with the foil thermal slide positioned over the sensing window, in the air stream entering the intake vent of the air conditioning system. When the probe is properly positioned tactile switch 58 of the probe is depressed to indicate the measurement is complete. At Step 910, the status of this measurement is determined. Once the measurement is complete, at Step 912, the temperature data from the probe is stored into memory, otherwise the process returns to Step 908. At Step 914, the change in temperature will be determined as the vent out temperature measurement less the vent in temperature measurement. At Step 916, a determination is made to see if the change in temperature is greater than 10 degrees. If the temperature is greater than 10 degrees, at Step 918, the data stored from the Pressure Diagnostics sub-routine will be retrieved. At Step 920, the low side and high side pressure values will be compared to stored acceptable data ranges. If the pressure values are within an acceptable range, at Step 922, a message “system function passes” will be displayed, the session will end and control will return to the main operating process 300. If the pressure values are not within an acceptable range, at Step 924, a message of “run 2^{nd} level testing” will be displayed to the user, the session will end and control will return to the main operating process 300. If, at Step 916, the change in temperature is determined to be less than 10 degrees, at Step 924, a message “run 2^{nd} level testing” will be displayed to the user, the session will end and control will return to the main operating process 300.

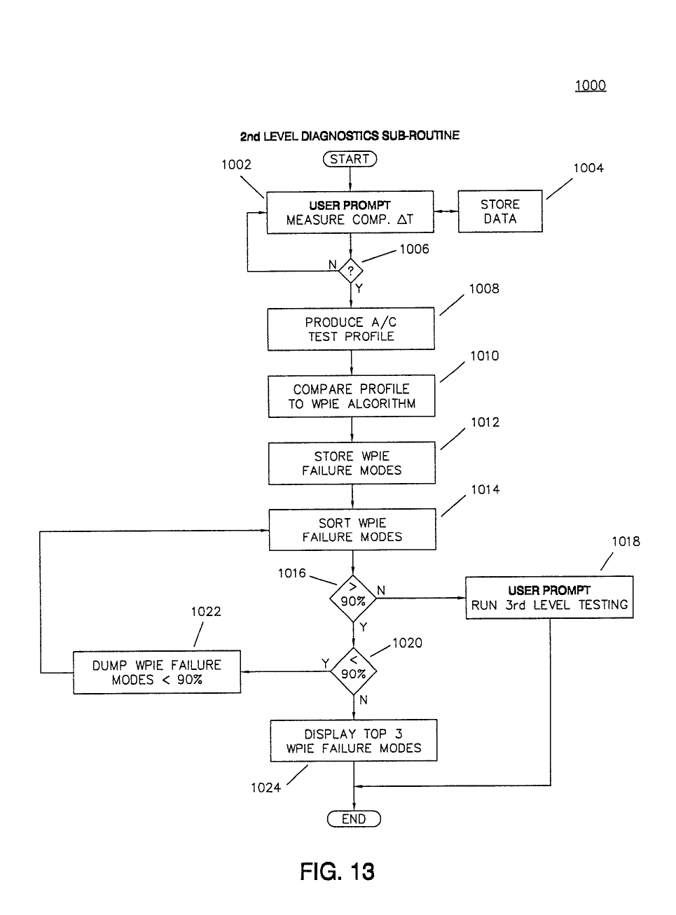

FIG. 13 depicts the 2^{nd} Level Diagnostics sub-routine 1000 of the main operating process 300. At Step 1002, the user will be prompted to measure the change in temperature across various air conditioning system components. Measurement will be made with the temperature probe foil thermal slide 86 positioned away from sensing window 82 and the sensing window is positioned onto the measuring point. Each measuring point will be covered with thermal target tape 40 to insure that a good temperature reading can be obtained. As each measurement is made tactile switch 58 of temperature probe 14 will be depressed to indicate the measurement is complete. At Step 1006, the status of this measurement is determined. Each data point that is read from the temperature probe will be stored to memory 1004 for use with the WPIE process. Required temperature measurements can include, but are not limited to, compressor inlet, compressor outlet, condenser inlet, condenser outlet, evaporator inlet, evaporator outlet, TXV or orifice inlet, TXV or orifice outlet. the temperature data from the probe is stored into memory. Once the measurement is complete, at Step 1008, all temperature measurements taken and previously stored temperature, pressure, clutch cycle speed and refrigerant status data will be utilized to create a test profile of the air conditioning system, otherwise the process returns to Step 1002. At Step 1010, the resulting test profile is compared to the WPIE process failure modes to determine possible matches of potential air conditioning system component-mode failures. At Step 1012, identified potential WPIE failure mode matches are stored into memory with the weighted probability assigned to each mode by the WPIE process. At Step 1014, the stored WPIE failure modes will be sorted from highest weighted probability to lowest weighted probability. At Step 1016, a determination will be made if all of the stored weighted modes are less than 90% weighted. If all stored modes are less than 90% weighted then, at Step 1018, a message of “run 3^{rd} level testing” will be displayed, the session will end and control will return to the main operating process 300. If some of the stored modes are greater than 90% weighted, at Step 1020, a determination will be made if some of the stored mode are less than 90% weighted. Stored modes with less than 90% weighted probability will be dumped from memory at Step 1022 and the resorting and determinations of 1014, 1016 and 1020 will be repeated. When only modes with weighted probabilities greater than 90% remain only the highest component-mode failure(s) will be reported to the user at Step 1024 through the display device. The session will end and control will return to the main operating process 300.

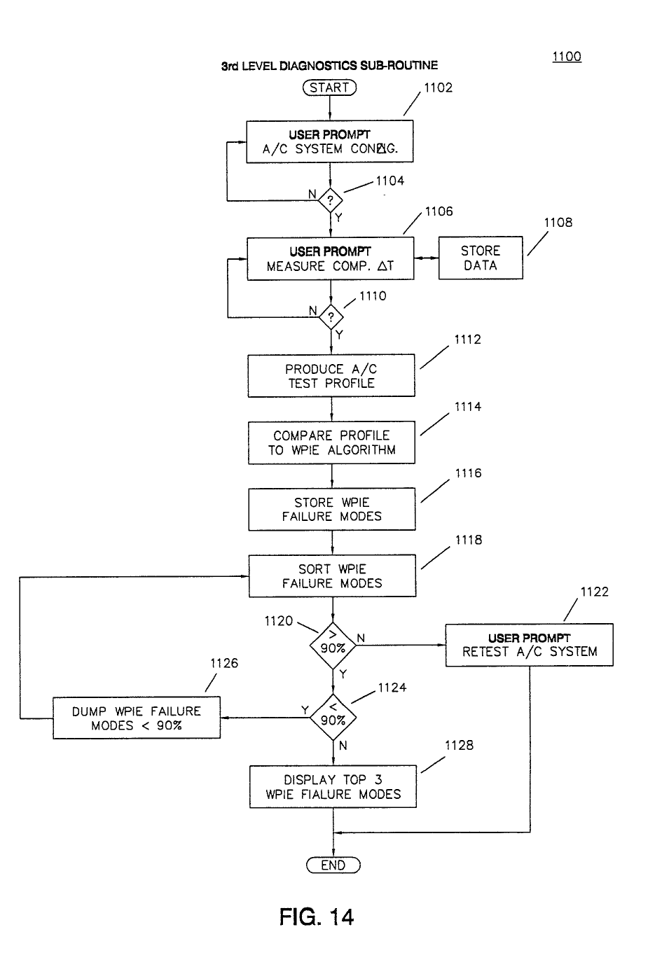

FIG. 14 depicts the 3^{rd} Level Diagnostics sub-routine 1100 of the main operating process 300. At Step 1102, the user will be prompted to reconfigure the operating parameters of the air conditioning system. Reconfiguration of the air conditioning system can involve, but is not limited to, increasing compressor idle speed or changing air conditioning control settings. At Step 1104, when the reconfiguration of the air conditioning system is complete the user will inform the microprocessor. At Step 1106, the user will be prompted to measure the change in temperature across various air conditioning system components. Measurement will be made with the temperature probe foil thermal slide positioned away from the sensing window and the sensing window positioned onto the measuring point. Each measuring point will be covered with thermal target tape to insure that a good temperature reading can be obtained. As each measurement is made tactile switch 58 of temperature probe 14 will be depressed to indicate the measurement is complete (Step 1110). At Step 1108, Each data point read from the temperature probe will be stored into memory for use with the WPIE process. Required temperature measurements can include, but are not limited to, compressor inlet, compressor outlet, condenser inlet, condenser outlet, evaporator inlet, evaporator outlet, TXV or orifice inlet, TXV or orifice outlet.

At Step 1112, all temperature measurements taken and previously stored temperature, pressure, clutch cycle speed and refrigerant status data will be utilized to create a test profile of the air conditioning system. At Step 1114, The resulting test profile will be compared to the WPIE process failure modes to determine possible matches of potential air conditioning system component-mode failures. At Step 1116, Identified potential WPIE failure mode matches will be stored to memory with the weighted probability assigned to each mode by the WPIE process. At Step 1118, The stored WPIE failure modes will be sorted from highest weighted probability to lowest weighted probability.

At Step 1120, a determination will be made if all of the stored weighted modes are less than 90% weighted. If all stored modes are less than 90% weighted, at Step 1122, a message “fault not detected” will be displayed, the session will end and control will return to the main operating process 300. At Step 1124, if some of the stored mode are greater than 90% weighted a determination will be made if some of the stored mode are less than 90% weighted. At Step 1126, stored modes with less than 90% weighted probability will be dumped from memory and the resorting and determinations of 1118, 1120 and 1124 will be repeated. At Step 1128, when only modes with weighted probabilities greater than 90% remain, only the highest component-mode failure(s) will be reported to the user through the display device, the session will end and control will return to the main operating process 300.

It is contemplated that one exemplary embodiment of the present invention may me a stand alone portable system for testing of both mobile and stationary refrigerant based systems. As used herein, a mobile refrigerant based system may be a system that is part of an automobile, bus, etc. Further, a mobile system may be any system capable of being moved from place to place such as a freezer, refrigerator, window mounted air conditioner, etc. By contrast a stationary refrigerant based system is any system that is not easily moved such as a central home or office air conditioning system.

Although the invention has been described with reference to exemplary embodiments, it is not limited thereto. Rather, the appended claims should be construed to include other variants and embodiments of the invention which may be made by those skilled in the art without departing from the true spirit and scope of the present invention.

What is claimed:

1. A device for testing a refrigerant based system having a plurality of operating parameters, the device comprising:
input means for obtaining the plurality of operating parameters from the refrigerant based system;
memory means for storing a plurality of baseline operating parameters; and
processing means coupled to the input means and the memory for i) processing the plurality of operating parameters, based on the plurality of baseline operating parameters, ii) generating a processing result, and iii) providing the processing result and prompts to a user.

2. The device according to claim 1, wherein the processing result indicates deficiencies in the refrigerant based system.

3. The device according to claim 2, wherein the prompts provide the user with instructions to correct the deficiencies in the refrigerant based system.

4. The device according to claim 3, wherein the user is provided diagnostic information based on the processing result from the processing means.

5. The device according to claim 2, wherein the prompts provide the user with information to identify a problem with the refrigerant based system.

6. The device according to claim 1, wherein the prompts provide the user with instructions to set up the testing of the refrigerant based system.

7. The device according to claim 1, wherein the processing means comprises i) a first processor coupled to the input means and ii) a second processor coupled to the first processor, the first processor providing the processing result to the second processor.

8. The device according to claim 7, wherein the second processor is a Personal Digital Assistant (PDA).

9. The device according to claim 7, wherein the second processor is detachably coupled to the first processor.

10. The device according to claim 1, further comprising display means coupled to the processing means to display the processing result and the prompts to the user.

11. The device according to claim 1, wherein the processing means includes a Weighted Probability Inference Engine (WPIE) to construct failure mode fingerprints of the refrigerant based system.

12. The device according to claim 11, wherein the memory means further stores historic operating data of the refrigerant based system.

13. The device according to claim 12, wherein the failure mode fingerprints are based on the historic operating data stored in the memory means and the operating parameters of the refrigerant based system.

14. The device according to claim 1, wherein the device measures at least one of:
an ambient temperature;
an ambient relative humidity;
a compressor inlet temperature;
a compressor outlet temperature;
a condenser inlet temperature;
a condenser outlet temperature;
an evaporator inlet temperature;
an evaporator outlet temperature;
a TXV inlet temperature;
an orifice inlet temperature;
a TXV outlet temperature;
an orifice outlet temperature;
a vent inlet temperature;
a vent outlet temperature;
an accumulator or receiver inlet temperature; and
an accumulator or receiver outlet temperature, of the refrigerant based system.

15. The device according to claim 1, further comprising an infrared probe for measuring a temperature of the refrigerant based system.

16. The device according to claim 1, wherein the refrigerant based system is a mobile system.

17. The device according to claim 1, wherein the refrigerant based system is a stationary system.

18. The device according to claim 1, wherein the device is portable.

19. The device according to claim 1, further comprising a refrigerant identifier coupled to the processing means to determine a type and a purity of refrigerant contained within the refrigerant based system.

20. The device according to claim 1, further comprising at least one communication port coupled to the processing means.

21. A probe for measuring a temperature of a refrigeration component of a refrigerant based system having a plurality of refrigeration components, the probe comprising:
an infrared sensor;
a display coupled to the infrared sensor to provide a temperature reading from the infrared sensor to a user; and
a filter for positioning between the infrared sensor the refrigeration component.

22. The probe according to claim 21, further comprising an infrared emitter, wherein the infrared emitter is applied to the refrigeration component, the infrared emitter emitting infrared radiation to the infrared sensor based on the temperature of the refrigeration component.

23. The probe according to claim 22, wherein the infrared emitter is a thermal tape.

24. The probe according to claim 21, further comprising a light source to illuminate the refrigeration component.

25. The probe according to claim 24, wherein the light source is an LED.

26. A probe in temperature communication with ambient air to measure a temperature of the ambient air, the probe comprising:
an infrared sensor;
a display coupled to the infrared sensor to provide a temperature reading from the infrared sensor to a user; and
a filter for positioning between the infrared sensor the ambient air.

27. The probe according to claim 26, further comprising a thermal converter for positioning between the infrared sensor and the filter, wherein the thermal converter converts thermal energy of the ambient air into infrared energy for detection by the infrared sensor.

28. The probe according to claim 27, wherein the thermal converter comprises a metallic black body.

29. A system for measuring a temperature of a refrigerant based apparatus having a plurality of refrigeration components, the system comprising:
an infrared sensor; and
an infrared emitter in temperature communication with one of the plurality of refrigeration components,
wherein the infrared emitter emits infrared radiation to the infrared sensor responsive to the temperature of the one refrigeration component.

30. The system according to claim 29, further comprising a display coupled to the infrared sensor to provide a temperature reading from the infrared sensor to a user.

31. The system according to claim 29, further comprising a filter for positioning between the infrared sensor and the infrared emitter.

32. The system according to claim 29, wherein the infrared emitter is a thermal tape applied to the one refrigeration component.

33. A system in temperature communication with ambient air for measuring a temperature of the ambient air, the system comprising:
an infrared sensor; and
an infrared emitter in temperature communication with the ambient air,
wherein the infrared emitter emits infrared radiation to the infrared sensor responsive to the temperature of the ambient air.

34. The system according to claim 33, further comprising a display coupled to the infrared sensor to provide a temperature reading from the infrared sensor to a user.

35. The system according to claim 33, further comprising a filter for positioning between the infrared sensor and the infrared emitter.

36. The system according to claim 33, wherein the infrared emitter comprises a metallic black body.

37. A process for testing a refrigerant based system having a plurality of operating parameters, the process comprising the steps of:
(a) obtaining the plurality of operating parameters from the refrigerant based system;
(b) storing a plurality of baseline operating parameters;
(c) processing the plurality of operating parameters, based on the plurality of baseline operating parameters and generating a processing result; and
(d) providing the processing result and prompts to a user based on the processing step.

38. The process according to claim 37, wherein the processing step (c) comprises the steps of:
(1) providing system specific data of the refrigerant based system;
(2) interfacing with the refrigerant based system;
(3) obtaining a plurality of internal measurement results from the refrigerant based system including at least one pressure of the refrigerant based system;
(4) obtaining an external measurement result of at least one of i) an ambient temperature and ii) a relative humidity;
(5) determining at least one failure mode fingerprint result of the refrigerant based system;
(6) determining at least one pressure component-mode failure result based on the at least one failure mode fingerprint result of Step (5) and the measurement results of at least one of Steps (3) and (4);
(7) determining a cooling effectiveness result of the system; and
(8) displaying at least one of the results of Steps (3) through (7) to the user.

39. The process according to claim 38, wherein the determining step (5) comprises the steps of:
(i) storing a plurality of predetermined failure modes in a memory;
(ii) initializing a failure mode count;
(iii) retrieving a first one of the plurality of failure modes from the memory;
(iv) determining at least one of a minimum value and a maximum value for the failure mode retrieved in Step (iii);
(v) determining if a respective one of the plurality of internal measurements obtained in step (3) is within the minimum value and the maximum value of the failure mode retrieved in step (iii);
(vi) grading the respective one of the plurality of measurements based on the determination in step (v);
(vii) storing the grading from step (vi) in the memory; and
(viii) repeating Steps (iii) through (vii) for each of the remaining plurality of measurements.

40. The method according to claim 38, wherein the failure mode fingerprints are stored in a matrix configuration.

41. The method according to claim 38, wherein the failure mode fingerprints include at least one of:
i) Low Performing Compressor;
ii) Evaporator Air Flow Restriction;
iii) Missing Orifice Tube;
iv) Slipping Compressor Clutch or Fan Belt;
v) Cooling Fan Disconnected;
vi) Blocked Orifice Tube;
vii) No Problem Detected;
viii) Condenser Restriction;
ix) Blend Door Malfunction;
x) Blocked Condenser Air Flow;
xi) Pressure Switch Setpoint Fault;
xii) Air in Refrigerant Charge;
xiii) 30% Low Refrigerant Charge;
xiv) 40% Low Refrigerant Charge;
xv) Suction Side Restriction;
xvi) Excessive Refrigerant Charge; and
xvii) TXV Valve Fault.

42. The process according to claim 38, further comprising the step) of determining a status of a refrigerant contained in the refrigerant based system.

43. The process according to claim 38, wherein the step (6) of determining at least one pressure component-mode failure result further comprises the steps of:
(i) obtaining a high side pressure data and a low side pressure data from the refrigerant based system;
(ii) storing a maximum and a minimum value for each of the high side pressure data and the low side pressure data;
(iii) determining if a refrigerant is present in the refrigerant based system;
(iv) providing diagnostic information to the user based on the determination in step (iii);
(v) calculating a difference in pressure between the high side pressure and the low side pressure;
(vi) providing diagnostic information to the user based on the calculation in step (v); and
(vii) determining a clutch cycling speed of the refrigerant based system based on the data from steps (i) and (ii).

44. The process according to claim 37, further comprising the step of determining a refrigerant purity of a refrigerant within the refrigerant based system.

45. The process according to claim 37, further comprising the steps of:
(a) measuring a change in temperature across at least one of a plurality of components of the refrigerant based system;
(b) constructing a test profile for the refrigerant based system based on the temperature measurements;
(c) providing a plurality of failure modes for the refrigerant based system;
(d) comparing the test profile with the plurality of failure modes;
(e) determining at least one potential failure mode match based on the comparison;
(f) assigning a probability to each potential failure mode match; and
(g) storing each potential failure mode match into a memory based on the assigned probability.

46. A device for testing a refrigerant based system having a plurality of operating parameters, the device comprising:
input means for obtaining the plurality of operating parameters from the refrigerant based system;
a memory for storing a plurality of baseline operating parameters;
a Weighted Probability Inference Engine (WPIE) to construct failure mode fingerprints of the refrigerant based system based on the plurality of baseline operating parameters and the plurality of operating parameters of the refrigerant bases system;
a second processor coupled to the memory means and containing the WPIE, the WPIE providing the failure mode fingerprints to the second processor, the second processor displaying prompts and troubleshooting information to a user based on the failure mode fingerprints.

47. The device according to claim 46, wherein the second processor is detachably coupled to the Weighted Probability Inference Engine.
